(19) United States
(12) Patent Application Publication
(10) Pub. No.: US 2025/0320814 A1
(43) Pub. Date: Oct. 16, 2025

(54) CARBON DIOXIDE INJECTION RATES IN SALINE AQUIFER ESTIMATION

(71) Applicant: Saudi Arabian Oil Company, Dhahran (SA)

(72) Inventors: Hussain Abdullah Alqahtani, Dammam (SA); Abdulaziz Tubayyeb, Riyadh (SA); Mohammed Shawaf, Dhahran (SA); Mohammed Ali, Qatif (SA); Nura Aljaafari, Al Khobar (SA)

(21) Appl. No.: 18/636,951

(22) Filed: Apr. 16, 2024

(51) Int. Cl. E21B 49/00; G01V 20/00

(52) U.S. Cl. CPC E21B 49/008; G01V 20/00; E21B 2200/20

(57) ABSTRACT

Systems, computer-readable storage media, and methods include receiving, from probes, petrophysical data indicative of reservoir conditions within a subterranean region. A water injectivity test executes within the subterranean region using test constants based on the petrophysical data. A water-related variable is generated by using an output of the water injectivity test. A well production potential is determined by using a nodal analysis and the output of the water injectivity test. Carbon dioxide injection rates are predicting by using a carbon dioxide estimation model. The carbon dioxide estimation model processes the water-related variables, the test constants, and a ratio of carbon dioxide density at reservoir condition to carbon dioxide density at standard conditions.

### TECHNICAL FIELD

The present disclosure applies to estimation of carbon dioxide injection rates in saline aquifers and, more specifically, to carbon dioxide injection rate estimation using water injectivity test data.

### BACKGROUND

Many petrophysical factors of deep tight reservoirs can influence completion performance, reservoir quality, and productivity along vertical and horizontal wells. Research and studies in this area have been using water injectivity tests and carbon dioxide injectivity tests to extract subterranean parameters to enhance well designs. For example, estimating a carbon dioxide injection rate can be used to define well planning, field implementation, and eventual success of a well flood. The quality of reservoirs can be benchmarked against carbon dioxide injectivity test results and well completion performance.

### SUMMARY

Implementations of the present disclosure are directed to well design optimization using petrophysical data. More particularly, implementations of the present disclosure are directed to carbon dioxide injection rate estimation using water injectivity test data.

In some implementations, a computer-implemented method includes: receiving, by one or more processors and from probes, petrophysical data indicative of reservoir conditions within a subterranean region; executing, by the one or more processors, a water injectivity test within the subterranean region using test constants based on the petrophysical data; generating, by the one or more processors and using an output of the water injectivity test, a water-related variable; determining, by the one or more processors and using a nodal analysis and the output of the water injectivity test, a well production potential; and predicting, by the one or more processors and using a carbon dioxide estimation model, carbon dioxide injection rates, the carbon dioxide estimation model processing the water-related variables, the test constants, and a ratio of carbon dioxide density at reservoir condition to carbon dioxide density at standard conditions.

In some implementations, a computer-implemented system includes: one or more processors; and a non-transitory computer-readable storage medium coupled to the one or more processors and storing programming instructions for execution by the one or more processors, the programming instructions instructing the one or more processors to perform operations including: receiving, from probes, petrophysical data indicative of reservoir conditions within a subterranean region; executing a water injectivity test within the subterranean region using test constants based on the petrophysical data; generating by using an output of the water injectivity test, a water-related variable; determining by using a nodal analysis and the output of the water injectivity test, a well production potential; and predicting and using a carbon dioxide estimation model, carbon dioxide injection rates, the carbon dioxide estimation model processing the water-related variables, the test constants, and a ratio of carbon dioxide density at reservoir condition to carbon dioxide density at standard conditions.

In some implementations, a non-transitory computer-readable media is encoded with a computer program, the computer program including instructions that when executed by one or more computers cause the one or more computers to perform operations including: receiving, from probes, petrophysical data indicative of reservoir conditions within a subterranean region; executing a water injectivity test within the subterranean region using test constants based on the petrophysical data; generating, by using an output of the water injectivity test, a water-related variable; determining, by using a nodal analysis and the output of the water injectivity test, a well production potential; and predicting, by using a carbon dioxide estimation model, carbon dioxide injection rates, the carbon dioxide estimation model processing the water-related variables, the test constants, and a ratio of carbon dioxide density at reservoir condition to carbon dioxide density at standard conditions.

The foregoing and other implementations can each optionally include one or more of the following features, alone or in combination. In particular, implementations can include all the following features:

In an aspect, combinable with any of the previous aspects, the petrophysical data includes neutron-density porosity logs, resistivity logs, image logs, gamma ray logs, pulse neutron capture logs, and nuclear magnetic resonance logs. In another aspect, combinable with any of the previous aspects, the test constants include a water injection rate. In another aspect, combinable with any of the previous aspects, the output of the water injectivity test includes a wellhead pressure and a bottom hole flowing pressure. In another aspect, combinable with any of the previous aspects, the water-related variable includes an injectivity index. In another aspect, combinable with any of the previous aspects, the computer-implemented method further includes: controlling, by the one or more processors, probe data collection using a probe data collection schedule defining a frequency of probe data collection for each device of one or more devices. In another aspect, combinable with any of the previous aspects, wherein the subterranean region includes a sink or a reservoir. In another aspect, combinable with any of the previous aspects, the computer-implemented method further includes: executing, by the one or more processors, subterranean region modeling. In another aspect, combinable with any of the previous aspects, the computer-implemented method further includes: selecting, by the one or more processors, an action plan including a well count and a surface equipment. In another aspect, combinable with any of the previous aspects, wherein the probes include any of a temperature probe, a pressure probe, a porosity probe, a gamma ray detector, a camera, and a nuclear magnetic resonance detector.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

Implementations described in the present disclosure, provide a prediction of super-critical carbon dioxide injection rates in saline aquifers using actual field water injectivity test data and results. Well configurations can be adjusted according to super-critical carbon dioxide injection rates. An advantage of the described technology is that it provides key recommended actions for improving well design to ensure well efficiency and well equipment operations. Furthermore, the described estimation of carbon dioxide injection rates avoids performance of carbon dioxide injectivity tests, using instead a prediction model including trainable machine learning models that integrate actual field water injectivity test data and results. Another advantage of the described technology is that the described estimation of carbon dioxide injection rates accelerates a well design process by eliminating resources (materials and industrial equipment usage) allocated to perform carbon dioxide injectivity tests. The estimation of carbon dioxide injection rates can be advantageously applied to a wide range of reservoirs, sinks, and subterranean conditions.

The details of one or more implementations of the subject matter of the specification are set forth in the accompanying drawings and the description below. Other features, aspects, and advantages of the subject matter can become apparent from the description, the drawings, and the claims.

### DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A is a block diagram of an example system that can be used to execute implementations of the present disclosure;

FIG. 1B is a block diagram of a portion of the example system that can be used to execute implementations of the present disclosure;

FIG. 2 depicts a flowchart illustrating an example process for estimation of super-critical carbon dioxide injection rates, in accordance with some example embodiments;

FIG. 3 depicts a block diagram illustrating a computing system, in accordance with some example embodiments; and

FIG. 4 illustrates hydrocarbon production operations, in accordance with some example embodiments.

When practical, like labels are used to refer to same or similar items in the drawings.

### DETAILED DESCRIPTION

The following detailed description describes techniques to estimate super-critical carbon dioxide injection rates in saline aquifers using actual field water injectivity test data and results. The described implementations provide an analysis of petrophysical data indicative of petrophysical conditions within a subterranean region received from probes. The probes can be attached to or integrated in an assessment well to generate probe data indicative of the petrophysical conditions within the subterranean region of the assessment well. For example, one or more probes can be attached to a downhole tool to generate gamma ray logging while drilling that can be used in combination with azimuthally focused density and neutron porosity tools. The probes can further include temperature and pressure sensors to detect water-related variables during a water injectivity test. The water-related variables are processed using a well model configured to execute a nodal analysis to determine a well production potential. The carbon dioxide injection rates can be estimated as a function of well production potential with the water-related variables, the test constants, and carbon dioxide density at reservoir conditions relative to carbon dioxide density at standard conditions.

Omitting carbon dioxide injection tests, the estimation of the super-critical carbon dioxide injection rates in saline aquifers protocol described in the present disclosure facilitate efficient design of wells according to petrophysical conditions of a particular subterranean region. Techniques of the present disclosure include the use of a water injectivity test that completes log data types and well models characterizing the respective subterranean region. The characterization of the respective subterranean region can be based on petrophysical parameters indicating and estimating reservoir quality and productivity that are related to each data type from static and dynamic perspectives.

The characterization techniques of the present disclosure can be used for conventional and unconventional reservoirs where conventional log analysis cannot distinguish between productive and non-productive layers, e.g., due to geological complexity. The high-resolution image logs and neutron spectroscopy data can also improve predictions about layer thickness and rock quality. In some sandstone reservoirs, for example, conventional log analysis displays common values across the entire target interval without contrast between productive and non-productive data. Dynamic tests, core plug analysis, and completion results can show that a portion of reservoir layers contribute to most of the flow in some complex sandstone reservoirs with high or low (e.g., below 5% effective) porosity. Insights from the respective subterranean region characterization including carbon dioxide injection rates provide a guide in determining target production layers for (but not limited to) geo-steering, pressure, and sampling data acquisition, well testing, and well completion. The techniques of the present disclosure can be used to find most productive reservoir layers by integrating multiple types of input that require standard logging data, neutron spectroscopy, advanced mud logging, advanced statistic, deterministic petrophysical analysis, nuclear magnetic resonance, image log interpretation and critical carbon dioxide injection rates.

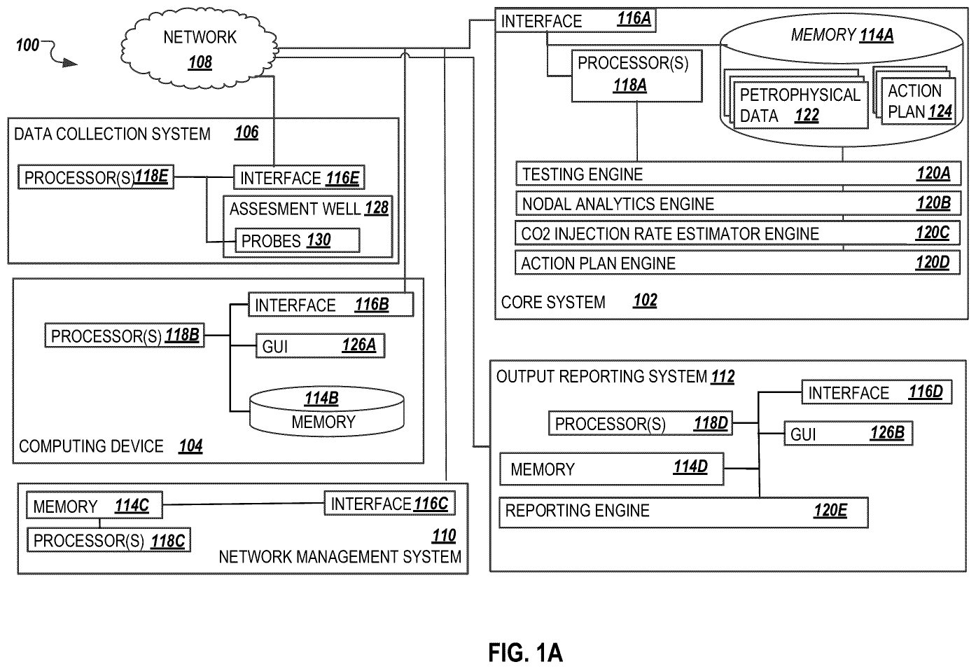

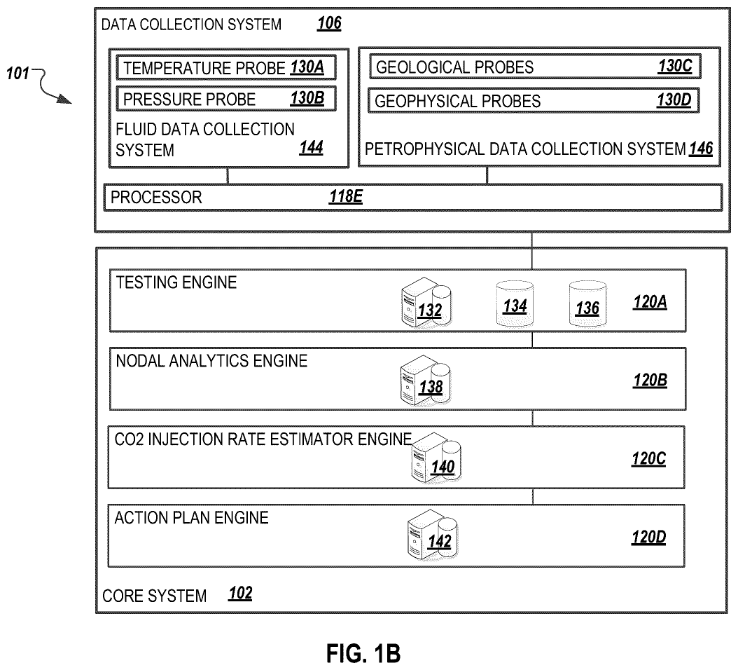

FIG. 1A is a block diagram illustrating an example system 100 that can be used to execute implementations of the present disclosure. For example, example system 100 can be configured to execute estimation of super-critical carbon dioxide injection rates. Specifically, the illustrated example system 100 includes or is communicably coupled with a core system 102, a computing device 104, a data collection system 106, a network 108, a network management system 110, and an output reporting system 112. Although shown separately, in some implementations, functionality of two or more systems or components of the example system 100 may be provided by a single system or server. In some implementations, the functionality of one illustrated system, server, or component may be provided by multiple systems, servers, or components, respectively.

In the example of FIG. 1A, the core system 102 is intended to represent various forms of servers including, but not limited to a web server, an application server, a proxy server, a network server, and/or a server pool. In general, the core system 102 manages estimation of super-critical carbon dioxide injection rates and coordinates well design within subterranean regions. In accordance with implementations of the present disclosure, and as noted above, the core system 102 can host a solution environment that can be a cloud environment providing software applications, systems, and services that can be consumed by customers as a service. In some instances, the core system 102 can support configuring of various tenants of different types, as well as services of different types that are integrated in customer integration scenarios and support execution of defined processes.

For example, the core system 102 includes a memory 114A, an interface 116A, a processor 118A, a testing engine 120A, a nodal analytics engine 120B, a carbon dioxide injection rate estimator engine 120C, and an action plan engine 120D. The memory 114A can include petrophysical data 122 and action plans 124. The petrophysical data 122 include data measured by and received from the data collection system 106. The petrophysical data 122 can include neutron-density porosity logs, resistivity logs, image logs, gamma ray logs, pulse neutron capture logs, and nuclear magnetic resonance logs. The petrophysical data 122 can be processed by any of the testing engine 120A, the nodal analytics engine 120B, the carbon dioxide injection rate estimator engine 120C, and the action plan engine 120D. The action plans 124 in the memory 114A can include action plan documents defining well designs and machine operations for well performance management.

The computing device 104, the network management system 110, and the output reporting system 112 may each be any computing device operable to connect to or communicate in the network(s) 108 using a wireline or wireless connection. In general, each of the computing device 104, the network management system 110, and the output reporting system 112 includes an electronic computer device operable to receive, transmit, process, and store any appropriate data associated with the example system 100 of FIG. 1A. Each of the computing device 104, the network management system 110, and the output reporting system 112 is generally intended to encompass any client computing device such as a laptop/notebook computer, wireless data port, smart phone, personal data assistant (PDA), tablet computing device, one or more processors within these devices, or any other suitable processing device. The computing device 104, the network management system 110, and the output reporting system 112, respectively include interface(s) 116B, 116C, 116D, processor(s) 118B, 118C, 118D, and memories 114B, 114C, 114D.

The computing device 104 and the output reporting system 112, respectively include graphical user interface(s) (GUIs) 126A and 126B. For example, the GUIs 126A, 126B include an input device, such as a keypad, touch screen, or other device that can accept user information, and an output device that conveys information associated with the operation of the core system 102, or the client device itself, including estimation of super-critical carbon dioxide injection rates based on petrophysical data (reports), and well design operations, respectively. The GUIs 126A, 126B each interface with at least a portion of the example system 100 for any suitable purpose, including generating a visual representation of the petrophysical data collected by the data collection system 106, the critical carbon dioxide injection rates generated by the core system 102, or data stored by the core system 102, such as petrophysical data 122 and action plans 124, respectively. In particular, the GUIs 126A, 126B may each be used to view and adjust various well modelling configurations. Generally, the GUIs 126A, 126B each provide the user with an efficient and user-friendly presentation of critical carbon dioxide injection rates provided by or communicated within the example system 100. The GUIs 126A, 126B may each include multiple customizable frames or views having interactive fields, pull-down lists, and buttons operated by the user. The GUIs 126A, 126B can each be any suitable graphical user interface, such as a combination of a generic web browser, intelligent engine, and command line interface (CLI) that processes information and efficiently presents the results to the user visually.

The output reporting system 112 can include a business intelligent (BI) module, the GUI 126B (dashboard), a user module, and administrator modules. The BI model utilizes the analytics data provided by the action plan engine 120D to produce executive and semi executive level displays for the GUI 126B. The GUI 126B displays a high-level summary of the critical carbon dioxide injection rate assessment, which provides support for well planning in addition to key recommended actions for well performance improvements. The GUI 126B display can facilitate well management and decision makers to modify (operations of) the planned wells. Additionally, the BI module provides an analyst level customized dashboard with a drill down capabilities to provide more detailed analysis for different working groups.

The data collection system 106 can include multiple probes 130 attached to or proximal to an assessment well 128. The probes 130 include any of a temperature probe, a pressure probe, a porosity probe, a gamma ray detector, a camera, and a nuclear magnetic resonance detector any of a temperature probe, a pressure probe, a porosity probe, a gamma ray detector, a camera, and a nuclear magnetic resonance detector. The processor 118E of the data collection system 106 controls operation of the probes 130 and directs collected data to the core system 102 for storage, further analysis, and modelling. The probes 130 can monitor petrophysical parameters at multiple locations within or proximal to the assessment well 128, such as within a wellhead and/or a bottom hole of the well. Further details about the probes 130 and their operation are provided with reference to FIG. 1B.

In some implementations, the network 108 can include a large computer network, such as a local area network, a wide area network, the Internet, a cellular network, a telephone network, or any appropriate combination thereof connecting any number of communication devices, mobile computing devices, fixed computing devices and server systems. Data exchanged over the network 108, is transferred using any number of network layer protocols, such as Internet Protocol, Multiprotocol Label Switching, Asynchronous Transfer Mode, Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 118A, 118B, 118C, 118D, 118E included in different components of the example system 100 can include a central processing unit, an application specific integrated circuit, a field-programmable gate array, or another suitable component. Generally, each processor 118A, 118B, 118C, 118D, 118E executes instructions and manipulates data to predict carbon dioxide injection rates. Specifically, each processor 118A, 118B, 118C, 118D, 118E executes a functionality required to monitor petrophysical data associated to an assessment well 128, to adjust well configurations, and to execute well operations.

Interfaces 116A, 116B, 116C, 116D, 116E are used by different components of the example system 100 for communicating with other component systems in a distributed environment—including within the example system 100—connected to the network 108. Generally, the interfaces 116A, 116B, 116C, 116D, 116E each include logic encoded in software and/or hardware in a suitable combination and operable to communicate with the network 108. More specifically, the interfaces 116A, 116B, 116C, 116D, 116E may each include software supporting one or more communication protocols associated with communications such that the network 108 or interface's hardware is operable to communicate physical signals within and outside of the illustrated system 100.

The memory 1114A, 114B, 114C, 114D may include any type of memory or database module and may take the form of volatile and/or non-volatile memory including, without limitation, magnetic media, optical media, random access memory, read-only memory, removable media, or any other suitable local or remote memory component. The memory 1114A, 114B, 114C, 114D may store various objects or data, including caches, classes, frameworks, applications, backup data, business objects, jobs, web pages, web page templates, database tables, database queries, repositories storing petrophysical data and/or dynamic information, and any other appropriate information including well models, and any well planning parameters, variables, algorithms, instructions, rules, constraints, or references thereto associated with the purposes of the core system 102, the computing device 104, the data collection system 106, the network management system 110, and the output reporting system 112, respectively.

There may be any number of computing devices 104 and data collection systems 106 associated with, or external to, the example system 100. Additionally, there may also be one or more additional client devices external to the illustrated portion of system 100 that are configured for interacting with the example system 100 via the network(s) 108. Further, the term “client,” “client device,” and “user” may be used interchangeably as appropriate without departing from the scope of the disclosure. Moreover, while client device may be described in terms of being used by a single user, the disclosure contemplates that many users may use one computer, or that one user may use multiple computers. As used in the present disclosure, the term “computer” is intended to encompass any suitable processing device. For example, although FIG. 1A illustrates a single core system 102, a single computing device 104, a single data collection system 106, a single network management system 110, the example system 100 can be implemented using a single, stand-alone computing device, two or more core systems 102, or multiple client devices. The core system 102, the computing device 104 and the output reporting system 112 may include any computer or processing device such as, for example, a blade server, general-purpose personal computer, workstation, or any other suitable device. In other words, the present disclosure contemplates computers other than general purpose computers, as well as computers without conventional operating systems. Further, the core system 102 and the computing device 104 and the output reporting system 112 may be adapted to execute any operating system or runtime environment. According to one implementation, the core system 102 may also include or be communicably coupled with an e-mail server, a Web server, a caching server, a streaming data server, and/or another suitable server, as described with reference to FIG. 1B.

FIG. 1B is a block diagram of a portion of the example system that can be used to execute implementations of the present disclosure. In particular, FIG. 1B depicts a schematic diagram illustrating an example portion 101 of a variation of the example system 100 described with reference to FIG. 1A, in accordance with some example embodiments. The example portion 101 of the example system 100 illustrated in FIG. 1B includes the core system 102 and the data collection system 106.

The core system 102 includes the testing engine 120A, the nodal analytics engine 120B, the carbon dioxide injection rate estimator engine 120C, and the action plan engine 120D. The testing engine 120A includes and a probe data processing module 132, a probe data collection database 134, and a result collection database 136. The testing engine 120A processes data received from the probe data collection database 134 and stores petrochemical analysis results in the result collection database 136. The petrochemical analysis results can be transmitted by the probe data processing module 132 of the testing engine 120A to the nodal analytics engine 120B for further processing.

The nodal analytics engine 120B includes a nodal analysis module 138. The nodal analysis module 138 processes data received from the probes at different positions within the assessment well to derive a variation (curve) of fluid parameters within the assessment well. In some implementations, the assessment well can include six or more segments (or nodes) and measurements from 3 of the nodes can be used to model the fluid characteristics across all nodes.

The carbon dioxide injection rate estimator engine 120C includes a carbon dioxide injection rate estimation module 140 that can estimate the carbon dioxide injection rate based on probe measured water injection rate. The carbon dioxide injection rate estimation module 140 delivers accurate real-time carbon dioxide injection rate estimation.

The action plan engine 120D includes a machine learning module 142 that processes the carbon dioxide injection rate and the petrophysical parameters to characterize subterranean regions and select an action plan. The action plan engine 120D provides reports indicative of the action plan. If the action plan implementation is not completed before a set time, the action plan engine 120D can escalate the implementation of the action plan, for example by triggering a backup set of automatic operations to manage well planning.

The data collection system 106 includes probes 130A, 130B, 130C, 130D coupled to different components of the well and can be distributed or can move between different segments of the well. The probes 130A, 130B, 130C, 130D are communicatively connected to the processor 118E. The probes 130A, 130B include temperature probes, pressure probes, velocity probes, and cameras. The probes 130A, 130B can collect petrophysical data, forming a fluid data collection system 144. The probes 130C, 130D can include geological probes and geophysical probes. The probes 130C, 130D can collect petrophysical data, forming a petrophysical data collection system 146.

While portions of the example system 100 illustrated in FIGS. 1A and 1B are shown as individual modules that implement the various features and functionality through various objects, methods, or other processes, the hardware components can execute software that can include multiple sub-modules, third-party services, components, libraries, and such, as appropriate. Conversely, the features and functionality of various components can be combined into single components as appropriate.

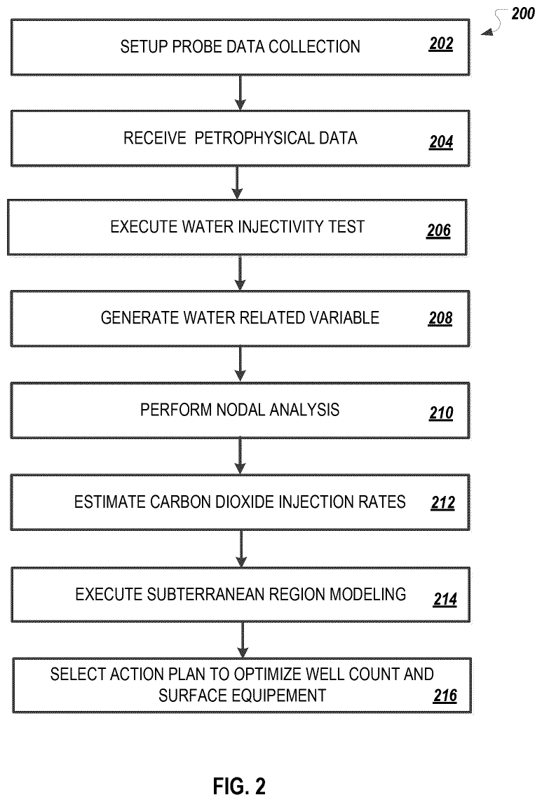

FIG. 2 depicts a flowchart illustrating an example process for estimation of super-critical carbon dioxide injection rates, in accordance with some example embodiments. Referring to FIGS. 1A and 1B, the process 200 can be performed by any components of the example system 100.

At 202, a probe configuration is setup for data collection. The probe configuration setup can include drilling an appraisal well to evaluate the quality of a geological subterranean formation that has a potential capacity to sequester carbon dioxide. The subterranean region includes a sink or a reservoir. The appraisal well can be positioned in the proximity of or within a sink or a reservoir. Multiple probes can be attached to or included in the appraisal well according to the probe configuration. The probe configuration setup can include configuring a collection of data using the probes to manage probe data collection. Setting up the probe configuration includes controlling probe data collection using a probe data collection schedule defining a frequency of probe data collection for each device of one or more devices. The probes include any of a temperature probe, a pressure probe, a fluid velocity detector (e.g., ultrasound transducer or Doppler probe), a porosity probe, a gamma ray detector, a camera, and a nuclear magnetic resonance detector, as described with reference to FIGS. 1A and 1B. Each of the probes can be configured to collect data according to a particular schedule defining a frequency of data collection and a duration of each collection duration. The probes can be configured to collect data continuously (according to the respective schedule) or can have a set trigger that initiates data collection in response to detection of one or more conditions for data collection. The conditions can be defined based on the appraisal well configuration, appraisal well operational conditions regarding an operational status (e.g., fully operational, partly operational, or minimally operational), and one or more devices (e.g., machines) attached to of the appraisal well (e.g., example system 100 described with reference to FIGS. 1A and 1B).

At 204, the probe data is received, by the one or more processors of a core system configured to process the probe data. The received probe data includes petrophysical data indicative of reservoir conditions within a subterranean region. The petrophysical data includes neutron-density porosity logs, resistivity logs, image logs, gamma ray logs, resistivity logs, pulse neutron capture logs, and nuclear magnetic resonance logs. The received probe data can be prefiltered by the probes that generated the probe data. For example, for conserving system resources by minimizing network traffic, the probe data can transmit noise free data potentially indicative of a petrophysical characteristics of the subterranean region.

For example, the gamma ray logs can include a non-azimuthally focused gamma ray log and an azimuthally focused density log generated by multiple tools. The resistivity logs can include data indicative of the presence of adjacent beds in the subterranean region. Additionally, observed disagreement between resistivity readings with hydrocarbon peaks of nuclear magnetic resonance logs can indicate the presence or absence of hydrocarbons in the subterranean region. The pulse neutron capture logs can include variations in pulsed neutron capture cross sections along the appraisal wells that can indicate high porosity/permeability unperforated productive zones.

In some implementations, image logs can be processed by zones as selected by sedimentologists or as correlated by shaly sand packages. Zonation of facies/depositional/rock typing and depositional environments can be based on sedimentologist inputs. Resistivity ranges can be correlated to lithology (e.g., sand, silt, or shale). An image can be reprocessed using resistivity ranges for developing reservoir layers image (e.g., image log analysis).

Nuclear magnetic resonance processing can occur using multiple bound fluid cutoffs and can be correlated to X-ray diffraction, X-ray fluorescence, and shaly sand analysis to accurately identify volumes for sand, silt, and clay. The image logs can be processed to refine vertical resolutions and to identify thin layers that are difficult to be determined (e.g., at better resolutions) by other logging tools.

Image data processing can be used to define the thickness and depth of multiple layers forming the subterranean region being analyzed. The processing can use core and mud log information for calibration. Nuclear magnetic resonance (NMR) processing can be used to identify the grain size distribution and to indicate movable versus non-movable fluid volume. Image logs can provide layer information that, combined with NMR, can be used to provide an estimation of movable and non-movable fluid percentages for a zone of interest. Image logs typically provide a higher resolution than other products, which allows further refinement of layering within the targeted reservoirs. Layering can be based on resistivity images that facilitate a precise determination of layer thickness and depth. Image logs have the highest vertical resolution relative to accurate depth determinations for identifying the thinnest layer possible.

At 206, a water injectivity test is executed within the subterranean region using test constants based on the petrophysical data. The test constants include a water injection rate. The water injectivity test is performed to measure an output including water injection data such as fluid velocity, flow rates, and flowing pressure at different positions within the appraisal well, corresponding to numbered nodes, such as wellhead flowing pressure, and bottom hole flowing pressure. The selected positions within the appraisal well, being allocated a numbered node, can be associated to multiple appraisal well components, such as a separator, a surface choke, a wellhead, a safety valve, a restrictor, and a bottomhole. For example, the separator can be allocated node position 1 and the bottomhole can be allocated node position 6.

At 208, a water-related variable is generated using an output of the water injection rate. The water-related variable can include a water injectivity index that can be indicative of a gradient of water injection data between two or more nodes, such as flowing pressure gradient between wellhead and bottom hole.

At 210, a well production potential is determined using a nodal analysis and the output of the water injectivity test. The nodal analysis includes an analysis of the injectivity test indexes to build well models using nodal analysis software packages to predict flowing pressure at a particular node, if the probe data corresponding to the selected node is not available. For example, if the flowing pressure at the bottom hole is missing, the bottom hole flowing pressure can be derived from received flowing pressure data of other nodes. The appraisal well model can be divided into two components: a reservoir or well capability component and a piping system component. The two components can be used to solve the flow rate at bottomhole (e.g., node position 6). The reservoir or well capability component can be derived from the water-related variables. The piping system component can be characterized using a multiphase flow correlation. The outcome of the nodal analysis indicates the required tubing intake pressures at a particular wellhead water flowing pressure, defining the wellhead water flowing pressure to the bottom hole water flowing pressure.

At 212, carbon dioxide injection rates are predicted using a carbon dioxide estimation model describing the flow (discharge rate q) as being proportional to the gradient in hydraulic head and the hydraulic conductivity. The carbon dioxide estimation model processes the water-related variables, the test constants, and a ratio of carbon dioxide density at reservoir condition to carbon dioxide density at standard conditions to generate a prediction of the carbon dioxide injection rates.

The carbon dioxide estimation model uses Darcy's law to describes the flow q of fluid (water or carbo dioxide) through a porous medium corresponding to the subterranean region.

$$q = \frac{- Δ P \times K h}{μ \times B} \qquad ( 1 )$$

The subterranean region is characterized by subterranean region characteristics including permeability k, ratio of surface to reservoir density B, and porosity (ϕ). The permeability k is a parameter particular to each soil type, which can be a scalar or a second-order tensor if the medium is anisotropic. The fluid (water or carbon dioxide) is characterized by fluid (water or carbon dioxide) characteristics including dynamic viscosity μ, the flow q (flux discharge per unit area, with units of length per time, m/s), and the pressure gradient vector Δp (Pa/m). The fluid velocity (v) is related to the Darcy flux (q) by the porosity (ϕ). The flux is divided by porosity to account for the fact that only a fraction of the total water volume is available for flow. The flow q of both water and carbon dioxide through the same porous medium corresponding to the subterranean region is described by:

$${q}_{water} = \frac{- Δ P \times K h}{{μ}_{w a t e r} \times {B}_{w a t e r}} \qquad ( 2 )$$

$${q}_{c} = \frac{- Δ P \times K h}{{μ}_{c} \times {B}_{c}} \qquad ( 3 )$$

Both equations are combined by assuming equal pressure drops.

$$Δ P = \frac{{μ}_{w a t e r} \times {B}_{w a t e r} \times {q}_{w a t e r}}{- K h} = \frac{{μ}_{c} \times {B}_{c} \times {q}_{c}}{- K h} \qquad ( 4 )$$

The injection rate q_{c} for carbon dioxide can be determined based on the subterranean region characteristics, the water characteristics, and the carbon dioxide characteristics as:

$${q}_{c} = \frac{- K h \times {μ}_{w a t e r} \times {B}_{w a t e r} \times {q}_{w a t e r}}{- K h \times {μ}_{c} \times {B}_{c}} \qquad ( 5 )$$

The carbon dioxide estimation model can include a simplification of the ratio of surface to reservoir density B_{c} and a definition of the ratio of water to carbon dioxide viscosity multiplied by the formation volume factor of water.

$${B}_{c} \approx \frac{{ρ}_{c surface}}{{ρ}_{c reservoir}} \qquad ( 6 )$$

$${C}_{test} = \frac{{μ}_{w a t e r} \times {B}_{w a t e r}}{{μ}_{c}} \qquad ( 7 )$$

The injection rate q_{c} for carbon dioxide can be estimated according to the carbon dioxide estimation model as a function of water-related variables (water injection rate), test constants, the carbon dioxide viscosity in the reservoir, relative to the surface carbon dioxide viscosity:

$${q}_{c} = \frac{{q}_{w a t e r} \times {C}_{t e s t} \times {ρ}_{c reservoir}}{{ρ}_{c surface}} \qquad ( 8 )$$

The carbon dioxide estimation model can substitute the water injection rate q_{water} with a function of the measured pressure drop ΔP and the water injectivity index II_{water}, such that the injection rate q_{c} for carbon dioxide can be determined as:

$${q}_{c} = \frac{Δ P \times {II}_{w a t e r} \times {C}_{t e s t} \times {ρ}_{c reservoir}}{{ρ}_{c surface}} \qquad ( 9 )$$

In some implementations, the test constant Cₜₑₛₜ=9.3E−06 for pressure range from 1700 psi-4000 psi, and the density constant ρ_{c surface}=1.87.

The carbon dioxide estimation model can include a machine learning model.

At 214, in response to determining the carbon dioxide injection rates, a subterranean modeling is executed. The subterranean modeling can be performed using a machine learning model configured to identify subterranean characteristics based on the determined carbon dioxide injection rate. The machine learning model can include a machine learning model pre-trained and fine-tuned to identify reservoir and sink features within a three-dimensional subterranean region by interpreting carbon dioxide injection rates relative to the detected probe data obtained from the probes. The machine learning models can be used to parameterize subterranean regions for fluid extraction. For example, a parameterized subterranean region with reservoir quality indicators (e.g., for chemical index ratio and weathering index) above 70 can be correlated as indicating a flowing permeability that facilitates fluid sampling and injectivity for fracking. The machine learning models can process the petrophysical data (e.g., including results of multimin analysis and shaly sand analysis, pore size distribution porosity and bound fluid volume) relative to carbon dioxide injection rates to quantify a potential fluid extraction from a reservoir of the subterranean region. The inputs of the machine learning models can include multiple independently measured geophysical characteristics that can be received and processed in real-time.

At 216, an action plan defining a well count and a corresponding surface equipment is selected. The action plan can be identified by machine learning models (e.g., recurrent neural networks with a multi-layer network topology) trained and fine-tuned to generate an automatic selection of an efficient distribution of multiple walls across the subterranean region relative to the assessment well and the reservoir or the sink. The surface equipment can be selected to match the characteristics of the wells and execute their intended operations. The trained machine learning models can be configured to operate in active mode, within the core system, facilitating automatic action plan implementation. For example, the trained machine learning models can trigger an initiation of the action plan, and a modification of surface equipment operations based on most recent probe data.

The example process 200 facilitates an accurate prediction of carbon dioxide injection rates in sinks and reservoirs without executing carbon dioxide injectivity tests. The example process 200 enhances a characterization of sink/reservoir carbon dioxide deliverability based on water injectivity tests that is used in the domain of carbon capture and sequestration. The example process 200 mitigates against risks of carbon dioxide supply interruptions that prevents carbon dioxide injectivity testing. Accurate carbon dioxide rate prediction facilitates better well modeling and completion design. The example process 200 provides resource (e.g., fluid and machine usage) conservation opportunities by eliminating the carbon dioxide injectivity test portion from evaluation (assessment) wells testing requirements. The example process 200 is based on a correlation of water injection rate to carbon dioxide injection rate that facilitates a rapid prediction of carbon dioxide injection rates by using the data obtained from water injectivity test. The example process 200 includes machine learning models that enhance reservoir modeling prediction and optimize well count and surface equipment planning.

In some implementations, in addition to (or in combination with) any previously described features, techniques of the example process 200 can include the following. The example process 200 can be performed before, during, or in combination with wellbore operations, such as to provide inputs to change the settings or parameters of equipment used for drilling. Examples of wellbore operations include forming/drilling a wellbore, hydraulic fracturing, and producing through the wellbore, to name a few. The wellbore operations can be triggered or controlled, for example, by outputs of the example process 200. In some implementations, customized user interfaces can present intermediate or final results of the above-described processes on a user interface of a user device. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, drilling parameters (including drill bit speed and direction) or overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period-of-time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. The described technology can be especially useful for systems or various pieces of equipment that are located several meters or several miles apart or are located in different countries or other jurisdictions.

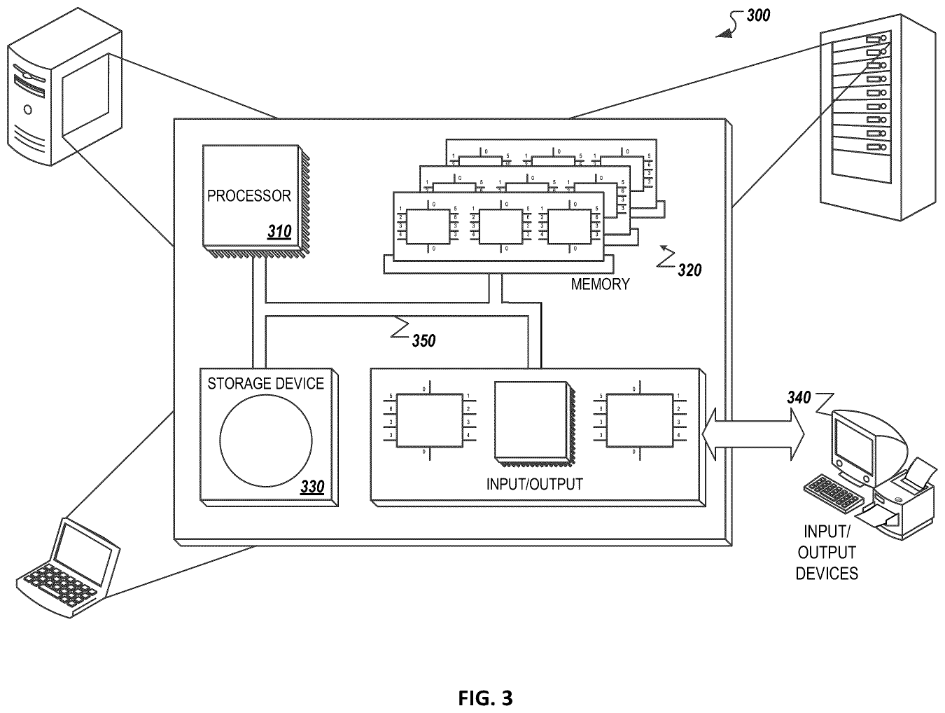

FIG. 3 depicts a block diagram illustrating a computing system 300, in accordance with some example embodiments. Referring to FIGS. 1A and 1B, the computing system 300 can be used to implement the core system 102 and/or any other components of the example system 100.

As shown in FIG. 3, the computing system 300 can include a processor 310, a memory 320, a storage device 330, and input/output devices 340. The processor 310, the memory 320, the storage device 330, and the input/output devices 340 can be interconnected using a system bus 350. The processor 310 is capable of processing instructions for execution within the computing system 300. Such executed instructions can implement one or more components of, for example, the example system 100. In some implementations of the current subject matter, the processor 310 can be a single-threaded processor. Alternately, the processor 310 can be a multi-threaded processor. The processor 310 is capable of processing instructions stored in the memory 320 and/or on the storage device 330 to display graphical information for a user interface provided using the input/output device 340.

The memory 320 is a computer readable medium such as volatile or non-volatile that stores information within the computing system 300. The memory 320 can store data structures representing configuration object databases, for example. The storage device 330 is capable of providing persistent storage for the computing system 300. The storage device 330 can be a floppy disk device, a hard disk device, an optical disk device, or a tape device, or other suitable persistent storage means. The input/output device 340 provides input/output operations for the computing system 300. In some implementations of the current subject matter, the input/output device 340 includes a keyboard and/or pointing device. In various implementations, the input/output device 340 includes a display unit for displaying graphical user interfaces.

According to some implementations of the current subject matter, the input/output device 340 can provide input/output operations for a network device. For example, the input/output device 340 can include Ethernet ports or other networking ports to communicate with one or more wired and/or wireless networks (e.g., a local area network (LAN), a wide area network (WAN), the Internet).

In some implementations of the current subject matter, the computing system 300 can be used to execute various interactive computer software applications that can be used for organization, analysis and/or storage of data in various (e.g., tabular) format (e.g., Microsoft Excel®, and/or any other type of software). Alternatively, the computing system 300 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 340. The user interface can be generated and presented to a user by the computing system 300 (e.g., on a computer screen monitor).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

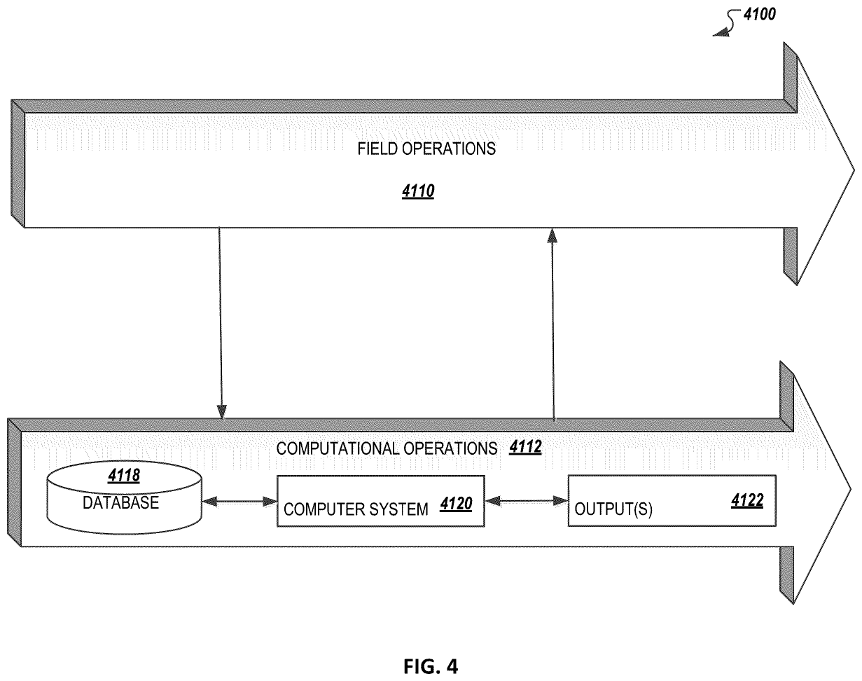

FIG. 4 illustrates hydrocarbon production operations 400 that include both one or more field operations 410 and one or more computational operations 412, which exchange information and control exploration to produce hydrocarbons. In some implementations, outputs of techniques of the present disclosure can be performed before, during, or in combination with the hydrocarbon production operations 400, specifically, for example, either as field operations 410 or computational operations 412, or both.

Examples of field operations 410 include forming/drilling a wellbore, hydraulic fracturing, producing through the wellbore, injecting fluids (such as water) through the wellbore, to name a few. In some implementations, methods of the present disclosure can trigger or control the field operations 410. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 410 and responsively triggering the field operations 410 including, for example, generating plans and signals that provide feedback to and control physical components of the field operations 410. Alternatively, or in addition, the field operations 410 can trigger the methods of the present disclosure. For example, implementing physical components (including, for example, hardware, such as sensors) deployed in the field operations 410 can generate plans and signals that can be provided as input or feedback (or both) to the methods of the present disclosure.

Examples of computational operations 412 include one or more computer systems 420 that include one or more processors and computer-readable media (e.g., non-transitory computer-readable media) operatively coupled to the one or more processors to execute computer operations to perform the methods of the present disclosure. The computational operations 412 can be implemented using one or more databases 418, which store data received from the field operations 410 and/or generated internally within the computational operations 412 (e.g., by implementing the methods of the present disclosure) or both. For example, the one or more computer systems 420 process inputs from the field operations 410 to assess conditions in the physical world, the outputs of which are stored in the databases 418. For example, seismic sensors of the field operations 410 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 412 where they are stored in the databases 418 and analyzed by the one or more computer systems 420.

In some implementations, one or more outputs 422 generated by the one or more computer systems 420 can be provided as feedback/input to the field operations 410 (either as direct input or stored in the databases 418). The field operations 410 can use the feedback/input to control physical components used to perform the field operations 410 in the real world.

For example, the computational operations 412 can process the seismic data to generate three-dimensional (3D) maps of the subsurface formation. The computational operations 412 can use these 3D maps to provide plans for locating and drilling exploratory wells. In some operations, the exploratory wells are drilled using logging-while-drilling (LWD) techniques which incorporate logging tools into the drill string. LWD techniques can facilitate the computational operations 412 to process new information about the formation and control the drilling to adjust to the observed conditions in real-time.

The one or more computer systems 420 can update the 3D maps of the subsurface formation as information from one exploration well is received and the computational operations 412 can adjust the location of the next exploration well based on the updated 3D maps. Similarly, the data received from production operations can be used by the computational operations 412 to control components of the production operations. For example, production well and pipeline data can be analyzed to predict slugging in pipelines leading to a refinery and the computational operations 412 can control machine operated valves upstream of the refinery to reduce the likelihood of plant disruptions that run the risk of taking the plant offline.

In some implementations of the computational operations 412, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications may be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method comprising: receiving, by one or more processors and from probes, petrophysical data indicative of reservoir conditions within a subterranean region; executing, by the one or more processors, a water injectivity test within the subterranean region using test constants based on the petrophysical data; generating, by the one or more processors and using an output of the water injectivity test, a water-related variable; determining, by the one or more processors and using a nodal analysis and the output of the water injectivity test, a well production potential; and predicting, by the one or more processors and using a carbon dioxide estimation model, carbon dioxide injection rates, the carbon dioxide estimation model processing the water-related variables, the test constants, and a ratio of carbon dioxide density at reservoir condition to carbon dioxide density at standard conditions.

Example 2. The computer-implemented method of example 1, wherein the petrophysical data comprises neutron-density porosity logs, resistivity logs, image logs, gamma ray logs, pulse neutron capture logs, and nuclear magnetic resonance logs.

Example 3. The computer-implemented method of any one of the previous examples, wherein the test constants comprise a water injection rate.

Example 4. The computer-implemented method of any one of the previous examples, wherein the output of the water injectivity test comprises a wellhead pressure and a bottom hole flowing pressure.

Example 5. The computer-implemented method of any one of the previous examples, wherein the water-related variable comprises an injectivity index.

Example 6. The computer-implemented method of any one of the previous examples, further comprising: controlling, by the one or more processors, probe data collection using a probe data collection schedule defining a frequency of probe data collection for each device of one or more devices.

Example 7. The computer-implemented method of any one of the previous examples, wherein the subterranean region comprises a sink or a reservoir.

Example 8. The computer-implemented method of any one of the previous examples, further comprising: executing, by the one or more processors, subterranean region modeling.

Example 9. The computer-implemented method of any one of the previous examples, further comprising: selecting, by the one or more processors, an action plan comprising a well count and a surface equipment.

Example 10. The computer-implemented method of any one of the previous examples, wherein the probes comprise any of a temperature probe, a pressure probe, a porosity probe, a gamma ray detector, a camera, and a nuclear magnetic resonance detector.

Example 11. A computer-implemented system comprising: one or more processors; and a non-transitory computer-readable storage medium coupled to the one or more processors and storing programming instructions for execution by the one or more processors, the programming instructions instructing the one or more processors to perform operations comprising: receiving, from probes, petrophysical data indicative of reservoir conditions within a subterranean region; executing a water injectivity test within the subterranean region using test constants based on the petrophysical data; generating by using an output of the water injectivity test, a water-related variable; determining by using a nodal analysis and the output of the water injectivity test, a well production potential; and predicting and using a carbon dioxide estimation model, carbon dioxide injection rates, the carbon dioxide estimation model processing the water-related variables, the test constants, and a ratio of carbon dioxide density at reservoir condition to carbon dioxide density at standard conditions.

Example 12. The computer-implemented system of example 11, wherein the petrophysical data comprises neutron-density porosity logs, resistivity logs, image logs, gamma ray logs, pulse neutron capture logs, and nuclear magnetic resonance logs.

Example 13. The computer-implemented system of any one of the previous examples, wherein the test constants comprise a water injection rate.

Example 14. The computer-implemented system of any one of the previous examples, wherein the output of the water injectivity test comprises a wellhead pressure and a bottom hole flowing pressure.

Example 15. The computer-implemented system of any one of the previous examples, wherein the water-related variable comprises an injectivity index.

Example 16. The computer-implemented system of any one of the previous examples, wherein the operations further comprise: controlling probe data collection using a probe data collection schedule defining a frequency of probe data collection for each device of one or more devices.

Example 17. The computer-implemented system of any one of the previous examples, wherein the subterranean region comprises a sink or a reservoir.

Example 18. The computer-implemented system of any one of the previous examples, wherein the operations further comprise: executing subterranean region modeling; and selecting an action plan comprising a well count and a surface equipment.

Example 19. The computer-implemented system of any one of the previous examples, wherein the probes comprise any of a temperature probe, a pressure probe, a porosity probe, a gamma ray detector, a camera, and a nuclear magnetic resonance detector.

Example 20. A non-transitory computer-readable media encoded with a computer program, the computer program comprising instructions that when executed by one or more computers cause the one or more computers to perform operations comprising: receiving, from probes, petrophysical data indicative of reservoir conditions within a subterranean region; executing a water injectivity test within the subterranean region using test constants based on the petrophysical data; generating, by using an output of the water injectivity test, a water-related variable; determining, by using a nodal analysis and the output of the water injectivity test, a well production potential; and predicting, by using a carbon dioxide estimation model, carbon dioxide injection rates, the carbon dioxide estimation model processing the water-related variables, the test constants, and a ratio of carbon dioxide density at reservoir condition to carbon dioxide density at standard conditions.

What is claimed is:

1. A computer-implemented method comprising:
receiving, by one or more processors and from probes, petrophysical data indicative of reservoir conditions within a subterranean region;
executing, by the one or more processors, a water injectivity test within the subterranean region using test constants based on the petrophysical data;
generating, by the one or more processors and using an output of the water injectivity test, a water-related variable;
determining, by the one or more processors and using a nodal analysis and the output of the water injectivity test, a well production potential; and
predicting, by the one or more processors and using a carbon dioxide estimation model, carbon dioxide injection rates, the carbon dioxide estimation model processing the water-related variables, the test constants, and a ratio of carbon dioxide density at reservoir condition to carbon dioxide density at standard conditions.

2. The computer-implemented method of claim 1, wherein the petrophysical data comprises neutron-density porosity logs, resistivity logs, image logs, gamma ray logs, pulse neutron capture logs, and nuclear magnetic resonance logs.

3. The computer-implemented method of claim 1, wherein the test constants comprise a water injection rate.

4. The computer-implemented method of claim 1, wherein the output of the water injectivity test comprises a wellhead pressure and a bottom hole flowing pressure.

5. The computer-implemented method of claim 1, wherein the water-related variable comprises an injectivity index.

6. The computer-implemented method of claim 1, further comprising:
controlling, by the one or more processors, probe data collection using a probe data collection schedule defining a frequency of probe data collection for each device of one or more devices.

7. The computer-implemented method of claim 1, wherein the subterranean region comprises a sink or a reservoir.

8. The computer-implemented method of claim 1, further comprising:
executing, by the one or more processors, subterranean region modeling.

9. The computer-implemented method of claim 1, further comprising:
selecting, by the one or more processors, an action plan comprising a well count and a surface equipment.

10. The computer-implemented method of claim 1, wherein the probes comprise any of a temperature probe, a pressure probe, a porosity probe, a gamma ray detector, a camera, and a nuclear magnetic resonance detector.

11. A computer-implemented system comprising:
one or more processors; and
a non-transitory computer-readable storage medium coupled to the one or more processors and storing programming instructions for execution by the one or more processors, the programming instructions instructing the one or more processors to perform operations comprising:
receiving, from probes, petrophysical data indicative of reservoir conditions within a subterranean region;
executing a water injectivity test within the subterranean region using test constants based on the petrophysical data;
generating, by using an output of the water injectivity test, a water-related variable;
determining, by using a nodal analysis and the output of the water injectivity test, a well production potential; and
predicting, by using a carbon dioxide estimation model, carbon dioxide injection rates, the carbon dioxide estimation model processing the water-related variables, the test constants, and a ratio of carbon dioxide density at reservoir condition to carbon dioxide density at standard conditions.

12. The computer-implemented system of claim 11, wherein the petrophysical data comprises neutron-density porosity logs, resistivity logs, image logs, gamma ray logs, pulse neutron capture logs, and nuclear magnetic resonance logs.

13. The computer-implemented system of claim 11, wherein the test constants comprise a water injection rate.

14. The computer-implemented system of claim 11, wherein the output of the water injectivity test comprises a wellhead pressure and a bottom hole flowing pressure.

15. The computer-implemented system of claim 11, wherein the water-related variable comprises an injectivity index.

16. The computer-implemented system of claim 11, wherein the operations further comprise:
controlling probe data collection using a probe data collection schedule defining a frequency of probe data collection for each device of one or more devices.

17. The computer-implemented system of claim 11, wherein the subterranean region comprises a sink or a reservoir.

18. The computer-implemented system of claim 11, wherein the operations further comprise:
executing subterranean region modeling; and
selecting an action plan comprising a well count and a surface equipment.

19. The computer-implemented system of claim 11, wherein the probes comprise any of a temperature probe, a pressure probe, a porosity probe, a gamma ray detector, a camera, and a nuclear magnetic resonance detector.

20. A non-transitory computer-readable media encoded with a computer program, the computer program comprising instructions that when executed by one or more computers cause the one or more computers to perform operations comprising:
receiving, from probes, petrophysical data indicative of reservoir conditions within a subterranean region;
executing a water injectivity test within the subterranean region using test constants based on the petrophysical data;
generating, by using an output of the water injectivity test, a water-related variable;
determining, by using a nodal analysis and the output of the water injectivity test, a well production potential; and
predicting, by using a carbon dioxide estimation model, carbon dioxide injection rates, the carbon dioxide estimation model processing the water-related variables, the test constants, and a ratio of carbon dioxide density at reservoir condition to carbon dioxide density at standard conditions.
